(19) United States
(12) Patent Application Publication
(10) Pub. No.: US 2003/0139898 A1
(43) Pub. Date: Jul. 24, 2003

(54) Method for synchronizing operation across devices

(76) Inventors: Daniel Halvard Miller, Waynesboro, VA (US); Robert Baxter Chambers II, Barboursville, VA (US); David John Hietanen, Charlottesville, VA (US)

Correspondence Address: CANTOR COLBURN, LLP, 55 GRIFFIN ROAD SOUTH, BLOOMFIELD, CT, 06002

(21) Appl. No.: 09/683,596

(22) Filed: Jan. 23, 2002

(51) Int. Cl. G04F 3/00; G06F 15/00

(52) U.S. Cl. 702/178

(57) ABSTRACT

Disclosed herein is a method of synchronizing the actions of one or more devices using an RF time signal. In one embodiment, a clock in a device is synchronized to an RF time signal, and the clock is applied in a timed event performed by the device. The timed event may include determining a time of occurrence of an event associated with the device or starting a process performed by the device at a predetermined time. In an alternative embodiment, the method includes: coordinating a first timed event to be performed by a first device and a second timed event to be performed by a second device; receiving an RF time signal at the first and second devices; synchronizing a first clock in the first device and a second clock in the second device to a time indicated in the RF time signal; applying the first clock in the first timed event performed by the first device; and applying the second clock in the second timed event performed by the second device. The first and second events may be performed simultaneously or at different times. A global positioning system receiver within each device may be used to compensate for any propagation delay of the RF time signal between the transmitter of the RF signal and the device.

### BACKGROUND OF INVENTION

Many large machines, factories, and systems have multiple devices that work together to produce a desired product or service. In many cases, it is critical that these devices initiate operations in synchronization with each other. Typically, such devices receive timing signals from a master controller over a hardwired network to synchronize the operations of all the devices. However, bandwidth and latencies of the communications channels between the devices and the master controller can delay the propagation of the timing signals to one or more of the devices, thereby adversely affecting their synchronization.

Another requirement that exists within many machines, factories, and systems is to accurately record when an event occurs. To accomplish this requirement, many devices within the machine, factory, or system have an automatic event-logging feature that logs the time of occurrence of any number of predetermined events. For example, if a device has a malfunction, the automatic event-logging feature of that device may record the time when the malfunction or other event occurred. A technician can then later review the log of recorded events in effort to determine the root cause of the malfunction. For such a log of events to be useful, the time of the event must be accurately recorded. However, power failures, power surges, and many other anomalies can cause the device to lose track of time, thereby causing inaccuracies in the event log.

### SUMMARY OF INVENTION

Disclosed herein is a method of synchronizing the actions of one or more devices. The method comprises: receiving an RF time signal; synchronizing a clock to a time indicated in the RF time signal; and applying the clock in a timed event performed by a device. The timed event may include at least one of: starting a process performed by the device at a predetermined time; and determining a time of occurrence of an event associated with the device.

In an alternative embodiment, the method of synchronizing the actions of one or more devices further comprises: determining a location of the first device using a GPS receiver; calculating a distance between a transmitter of the RF time signal and the first device using the location of the first device; calculating a propagation delay of the RF time signal from the transmitter to the first device using the distance; and synchronizing the first clock using the propagation delay.

In another alternative embodiment, a method of synchronizing the actions of one or more devices includes: coordinating a first timed event to be performed by a first device and a second timed event to be performed by a second device; receiving an RF time signal at the first device; synchronizing a first clock to a time indicated in the RF time signal; receiving the RF time signal at the second device; synchronizing a second clock to the time indicated in the RF time signal; applying the first clock in the first timed event performed by the first device; and applying the second clock in the second timed event performed by the second device.

### BRIEF DESCRIPTION OF DRAWINGS

Referring now to the drawings wherein like elements are numbered alike in several Figures:

FIG. 1 is a block diagram of a system for synchronizing a device;

FIG. 2 is a block diagram of a system for synchronizing multiple devices; and

FIG. 3 is a block diagram of an alternative embodiment of a system for synchronizing multiple devices.

### DETAILED DESCRIPTION

Described below with reference to the various figures and embodiments, are a method and a system for synchronizing the actions of one or more devices. In one embodiment, a controller in each of the one or more devices receives a broadcast radio frequency (RF) signal and synchronizes a clock to the time indicated by the broadcast RF signal. Each device applies its clock in one or more timed event. Such timed events may include, for example: starting or stopping a process performed by the device at a predetermined time, and determining the time of occurrence of an event associated with the device. The timed events of all devices may be coordinated such that the devices work together to perform a common function. A global positioning system (GPS) receiver may be coupled to the controller to compensate for any propagation delay associated with the broadcast RF signal.

Using a broadcast RF time signal to synchronize the one or more devices ensures that each of the devices receives the signal at the same time, with little propagation delay. This, in turn, ensures that the clocks in all devices will be accurately synchronized to a known time. As a result, the timed events performed by the devices will be accurate. Because each device can be counted on to perform their timed events accurately, a group of devices can be arranged to perform a common function, even where the common function requires intricately synchronized operation between the devices. Exemplary embodiments of the method and system for synchronizing the actions of one or more devices will now be described in further detail.

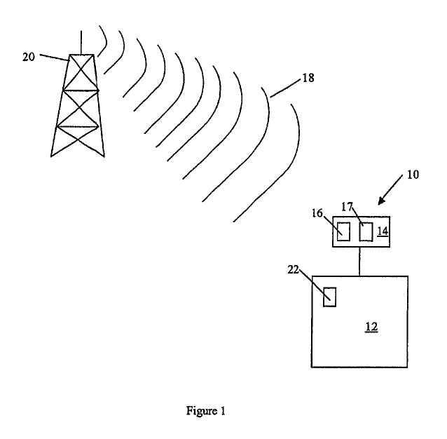

Referring to FIG. 1, an exemplary embodiment of a system 10 for synchronizing the actions of one or more devices is shown. System 10 includes a device 12, which is in operable communication with a controller 14. Controller 14 may include, for example, one or more of: an electrical circuit, a PLC, a microprocessor, or the like. Controller 14 includes a receiver 16 for receiving an RF time signal 18, which is continuously or periodically emitted from one or more transmitters 20. Transmitter 20 is any transmitter that transmits time information via RF waves. For example, transmitter 20 may be a radio station such as those operated by the National Institute of Standards and Technology under the call letters WWVB, WWV, or WWH. Receiver 16 is configured to receive the RF time signal and convert the RF time signal 18 into an analog or digital electronic signal. Receiver 16 may be an antenna or any commercially available time signal receiver. Controller 14 may also include a GPS receiver 17 configured to receive information on the location of device 12.

Device 12 includes a clock 22, which is used to perform some timed event in device 12. Such timed events include, for example: starting or stopping a process performed by device 12 at a predetermined time, and determining the time of occurrence of an event associated with the device 12. While clock 22 is shown internal to device 12, it will be recognized that clock 22 may be located external to device 12 or as part of controller 14. Receiver 16, controller 14, and clock 22 may be constructed as described in U.S. Pat. No. 4,569,598 to Jacobs, entitled Radio Synchronized Clock, or as described in U.S. Pat. No. 6,269,055 to Pikula et al., entitled Radio-Controlled Clock Movement.

System 10 operates in the following manner. Transmitter 20 sends RF time signal 18 over a known frequency. Receiver 16 receives RF time signal 18 and converts the RF time signal 18 into an analog or digital electronic time signal. Controller 14 receives the electronic time signal and adjusts clock 22 to the time indicated by the electronic time signal. This adjustment may be performed periodically, or upon device 12 startup. Optionally, the controller 14 will adjust the clock 22 to the time indicated by the electronic time signal plus an amount of time to account for any propagation delay of the RF time signal between the transmitter 20 and the receiver 16, and to account for any processing delay between receipt of the RF time signal 18 and the setting of clock 22. The propagation delay between the transmitter 20 and the receiver 16 can be calculated by first determining a location of the receiver 16 using the GPS receiver 17, then comparing the location of receiver 16 with a known location of transmitter 20 to determine a distance between the transmitter 20 and the receiver 16. Finally, the time that it takes the signal to travel from transmitter 20 to receiver 16 (i.e., the signal propagation delay) is determined by multiplying this distance by known RF signal propagation rates.

Device 12 applies clock 22 in one or more timed event. Such timed events include, for example: starting or stopping a process performed by device 12 at a predetermined time, and determining the time of occurrence of an event associated with the device 12.

An example of a timed event that may be performed by device 12 is as follows. In this example, device 12 is a flow meter in a hydraulic piping system. The device 12 includes an automatic event-logging feature that performs two timed events. First, the device 12 records fluid flow at predetermined times. Second, the device 12 records the present time whenever fluid flow through the meter exceeds some predetermined (e.g., maximum) flow rate. In operation, transmitter 20 sends RF time signal 18 over a known frequency. Receiver 16 receives RF time signal 18 and converts the RF time signal into an analog or digital electronic time signal. Controller 14 receives the electronic time signal and periodically adjusts clock 22 to the time indicated by the electronic time signal plus any propagation or processing delay. The event-logging feature monitors clock 22 and records the flow rate at predetermined times. The event-logging feature also monitors flow rate and retrieves the current time from clock 22 at the moment that flow rate exceeds some predetermined limit.

Because clock 22 is set automatically by controller 14 using RF signals, there is no risk that the time indicated by clock and recorded by the event-logging feature is inaccurate. If the clock 22 should lose track of time because of some interruption (e.g., loss of power, replacement, or the like) controller 14 will synchronize clock 22 to a known time when power is restored. Thus, system 10 ensures that processes performed by the device 12 (e.g., recording flow rate at predetermined times) subsequent to the interruption will be performed on-time. In addition, system 10 ensures that the time of occurrence of events (e.g., flow rates above the predetermined maximum) occurring subsequent to the interruption will be accurately recorded. It will be recognized that, while device 12 is a flow meter in the example described above, device 12 can be any machine that applies clock 22 in one or more timed event.

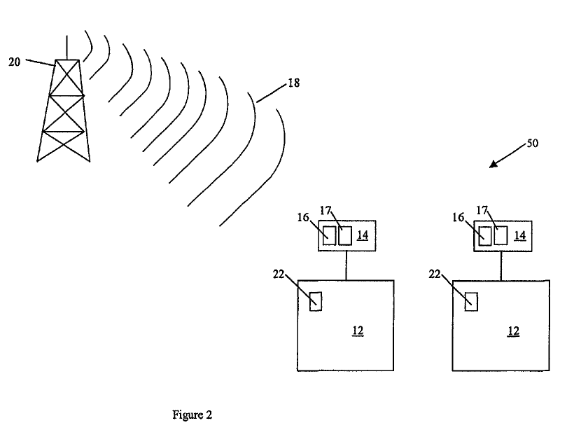

FIG. 2 illustrates another exemplary embodiment in which a system 50 includes a plurality of devices 12 that work together to perform a common function. The devices 12 may be located near each other or may be separated by any distance. Each device 12 includes a clock 22, and each device 12 applies its own clock 22 to perform one or more timed event. The one or more timed event performed by each device 12 may include, for example, one or more of: starting or stopping a process performed by device 12 at a predetermined time, and determining the time of occurrence of an event associated with the device 12. The one or more timed event performed by each device 12 is coordinated with the one or more timed event performed by the other devices 12 such that all devices 12 perform part of a common function. Each device 12 is in operable communication with their own controller 14, each of which includes a receiver 16 for receiving RF time signal 18 transmitted from transmitter 20.

System 50 operates in the following manner. Transmitter 20 sends RF time signal 18 over a known frequency. Receivers 16 receive RF time signal 18 and convert the RF time signal into an analog or digital electronic time signal. Each controller 14 receives the electronic time signal from an associated receiver 16 and adjusts an associated clock 22 to the time indicated by the electronic time signal. This adjustment may be performed periodically, or upon device 12 startup. Optionally, each controller 14 will adjust the clock 22 to the time indicated by the electronic time signal plus an amount of time to account for any propagation delay of the RF time signal between the transmitter 20 and the associated receiver 16, and to account for any processing delay between receipt of the RF time signal 18 and the setting of the associated clock 22. The propagation delay between the transmitter 20 and the receiver 16 can be calculated as discussed above, with reference to FIG. 1.

Each device 12 applies its clock 22 in one or more timed event. The timed events are coordinated such that the devices 12 work together to perform part of a common function for system 50. The common function can be any function performed by system 50 as a whole.

An example of a common function that can be performed by system 50 is as follows. In this example, each device 12 is a flow meter in a hydraulic piping system. The devices 12 may be located near each other or may be separated by any distance. Each device 12 includes an automatic event-logging feature that performs the timed event of recording fluid flow at predetermined times. System 50 performs the common function of detecting when and where a leak occurs in the piping system. This function is accomplished by comparing the event logs maintained by the devices 12 in system 50, and identifying an instance where flow at one device 12 is different than flow at an adjacently located device 12 at any one time.

In operation, transmitter 20 sends RF time signal 18 over a known frequency. Receivers 16 receive RF time signal 18 and convert the RF time signal into an analog or digital electronic time signal. Controllers 14 receive the electronic time signals and periodically adjust clocks 22 to the time indicated by the electronic time signal. The event-logging feature in each device 12 monitors its clock 22 and records the flow rate at predetermined times. Periodically, operations personnel or a central controller (not shown) compares the flow rates recorded by devices 12 at each predetermined time to detect instances where the flow at one device 12 is different than flow at an adjacently located device 12. Where flow rate at adjacent devices 12 is different for a given time, a leak has been detected.

Because clock 22 in each device 12 is set automatically by controller 14 using RF signals, each clock 22 in each device 12 will be synchronized to the same time. There is no risk that the time recorded by the different devices 12 will be inaccurate. As a result, any number of devices 12 can form a system 50 for performing a common function; even where the common function requires intricately synchronized operation between the devices 12. In addition, using the RF signals to synchronize the devices 12 allows the devices to by highly synchronized without requiring interconnection of the devices 12 by a wiring network, which can be costly for devices 12 that are located at a great distance from each other. Moreover, if either clock 22 should lose track of time because of some interruption (e.g., loss of power, replacement, or the like) the controller 14 associated with that clock 22 will synchronize that clock 22 to a known time when power is restored. Thus, system 10 ensures that processes performed by each device 12 subsequent to the interruption will be performed on-time. While system 50 is described here as a system of flow meters, it will be recognized that system 50 can be any system wherein each device 12 applies its clock 22 in one or more timed event, the timed events of all devices 12 being coordinated such that the devices 12 work together to perform a common function.

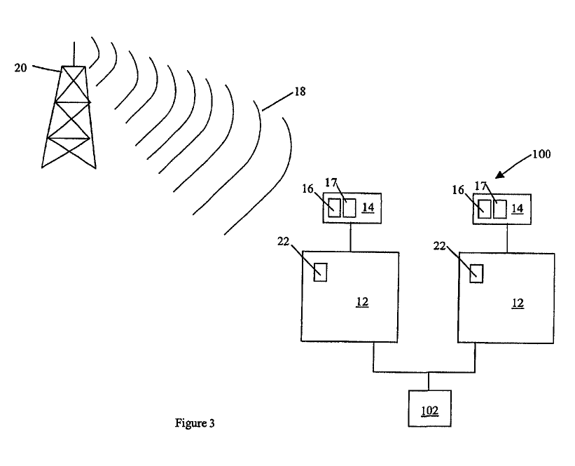

FIG. 3 illustrates another exemplary embodiment in which a system 100 includes a plurality of devices 12 in operable communication with a master controller 102. Each device 12 includes a clock 22, and each device applies its own clock 22 to perform one or more timed event. The one or more timed event performed by each device 12 may include, for example, one or more of: starting or stopping a process performed by device 12 at a predetermined time, and determining the time of occurrence of an event associated with the device 12. The one or more timed event performed by each device 12 is coordinated with the one or more timed events performed by the other devices 12 such that all devices 12 perform part of a common function for system 100. Each device 12 is in operable communication with its own controller 14, which includes a receiver 16 for receiving RF time signal 18 transmitted from transmitter 20. Each device 12 is also in operable communication with a master controller 102. Master controller 102 may include, for example, one or more of: an electrical circuit, a programmable logic controller (PLCs), a microprocessor, a computer, and the like. Master controller 102 may be configured to provide the devices 12 with one or more instructions for performing the one or more timed event, along with a time that the one or more timed event is to be performed. Master controller may also be configured to receive data indicating logged events from logging features in the various devices 12.

Operation of system 100 will now be described. Master controller 102 coordinates the timed events such that the devices 12 work together to perform a common function for system 100. Master controller 102 then sends a signal to each device 12 indicating one or more timed event that the device 12 must perform and a time at which the one or more event is to be performed. Transmitter 20 sends RF time signal 18 over a known frequency. Receivers 16 receive RF time signal 18 and convert the RF time signal into an analog or digital electronic time signal. Each controller 14 receives the electronic time signal from an associated receiver 16 and adjusts its associated clock 22 to the time indicated by the electronic time signal. This adjustment may be performed periodically, or upon device 12 startup. Optionally, each controller 14 will adjust its associated clock 22 to the time indicated by the electronic time signal plus an amount of time to account for any propagation or processing delay, as described with reference to FIGS. 2 and 3. Each device 12 applies its clock 22 in the one or more timed event indicated by the signal previously received from master controller 102. The timed event performed by each device 12 is part of the common function performed by system 100 as a whole.

An example of an application of system 100 is an assembly process, where system 100 represents a machine or assembly line whose common function is to manufacture a product. Each device 12 represents a device whose timed event is to assemble a unique part of the product at a predetermined start time. Master controller 102 coordinates the timed event of each device 12 such that the product is manufactured in a proper sequence. In operation, master controller 102 sends a signal to each device 12 indicating the times at which each device 12 is to assemble its part. Each device 12 stores this information. Receivers 16 receive RF time signal 18 and convert the RF time signal into an analog or digital electronic time signal. Controllers 14 receive the electronic time signal from their respective receivers 16 and read the time from the electronic time signal. Each controller 14 then adjusts its associated clock 22 to the time indicated by the electronic time signal. This adjustment may be performed periodically, or upon device 12 startup. Optionally, each controller 14 will adjust its associated clock 22 to the time indicated by the electronic time signal plus an amount of time to account for any delay between receipt of the RF time signal 18 and the setting of clock 22. Each device 12 monitors its clock 22. When the time previously indicated by the signal from master controller 102 arrives, each device 12 assembles part of the product.

Because clock 22 in each device 12 is set automatically by controller 14 using RF signals, each clock 22 in each device 12 will be synchronized to the same time. There is no risk that a device 12 will perform its timed event, e.g., assemble a part, at the wrong time. As a result, master controller 102 is able to coordinate the timed events of each device 12 in advance by providing each device with instructions indicating one or more timed event that the device 12 must perform and a time at which the one or more function is to be performed. Because these instructions may be sent well before the event occurs, bandwidth and latencies of the communications channels between the devices 12 and the master controller 102 are not a factor in the synchronization of the devices 12. To the contrary, the ability to schedule an event to occur in the future and be synchronized across multiple controllers not only significantly reduces communications bandwidth requirements but also causes latencies o be determined only by the accuracy of the clocks 22. Moreover, if either clock 22 should lose track of time because of some interruption (e.g., loss of power, replacement, or the like) the controller 14 associated with that clock 22 will synchronize that clock 22 to a known time when power is restored. Thus, system 10 ensures that processes performed by each device 12 subsequent to the interruption will be performed on-time. While system 100 is described here as a machine or assembly line for manufacturing a product, it will be recognized that system 100 can be any system wherein each device 12 applies its clock 22 in one or more timed event, the timed events of all devices 12 being coordinated by master controller 102 such that the devices 12 work together to perform a common function.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of synchronizing the actions of one or more devices, comprising:
receiving an RF time signal;
synchronizing a first clock using a time indicated in said RF time signal; and
applying said first clock in a first timed event performed by a first device.

2. The method of claim 1, wherein said first timed event includes:
at a predetermined time, starting a process performed by said first device.

3. The method of claim 1, wherein said first timed event includes:
at a predetermined time, stopping a process performed by said first device.

4. The method of claim 1, wherein said first timed event includes:
determining a time of occurrence of an event associated with said first device.

5. The method of claim 2, further comprising:
prior to applying said first clock in said first timed event, providing a signal indicating said predetermined time to said first device.

6. The method of claim 5, wherein said signal further indicates said process to be performed at said predetermined time.

7. The method of claim 1, further comprising:
synchronizing a second clock using the time indicated in said RF time signal; and
applying said second clock in a second timed event performed by a second device, said first timed event and said second timed event are coordinated such that devices 12 work together to perform a common function.

8. The method of claim 7, wherein said first timed event includes at least one of:
at a first predetermined time, starting a process performed by said first device, and
determining a time of occurrence of an event associated with said first device; and
wherein said second timed event includes at least one of:
at a second predetermined time, starting a process performed by said second device, and
determining a time of occurrence of an event associated with said second device.

9. The method of claim 8, further comprising:
prior to applying said first clock in said first timed event, providing a signal indicating said first predetermined time to said first device; and
prior to applying said second clock in said second timed event, providing a signal indicating said second predetermined time to said second device.

10. The method of claim 9, wherein said signal indicating said first predetermined time further indicates said process to be performed by said first device at said first predetermined time, and said signal indicating said second predetermined time further indicates said process to be performed by said second device at said second predetermined time.

11. The method of claim 1, further including:
determining a location of said first device using a GPS receiver;
calculating a distance between a transmitter of said RF time signal and said first device using said location of said first device;
calculating a propagation delay of said RF time signal from said transmitter to said first device using said distance; and
synchronizing said first clock using said propagation delay.

12. A method of synchronizing the actions of one or more devices, comprising:
coordinating a first timed event to be performed by a first device and a second timed event to be performed by a second device;
receiving an RF time signal at said first device;
synchronizing a first clock using a time indicated in said RF time signal;
receiving said RF time signal at said second device;
synchronizing a second clock using said time indicated in said RF time signal;
applying said first clock in said first timed event performed by said first device; and
applying said second clock in said second timed event performed by said second device.

13. The method of claim 12, wherein said first timed event includes at least one of:
at a first predetermined time, starting a process performed by said first device, and
determining a time of occurrence of an event associated with said first device; and
wherein said second timed event includes at least one of:
at a second predetermined time, starting a process performed by said second device, and
determining a time of occurrence of an event associated with said second device.

14. The method of claim 13, further comprising:
prior to applying said first clock in said first timed event, providing a signal indicating said first predetermined time to said first device; and
prior to applying said second clock in said second timed event, providing a signal indicating said second predetermined time to said second device.

15. The method of claim 14, wherein said signal indicating said first predetermined time further indicates said process to be performed by said first device at said first predetermined time, and said signal indicating said second predetermined time further indicates said process to be performed by said second device at said second predetermined time.

16. The method of claim 12, further including:
determining a location of said first device using a first GPS receiver;
calculating a first distance between a transmitter of said RF time signal and said first device using said location of said first device;
calculating a first propagation delay of said RF time signal from said transmitter to said first device using said first distance;
synchronizing said first clock using said first propagation delay;
determining a location of said second device using a second GPS receiver;
calculating a second distance between a transmitter of said RF time signal and said second device using said location of said second device;
calculating a second propagation delay of said RF time signal from said transmitter to said second device using said second distance; and
synchronizing said second clock using said second propagation delay.
